(19) United States
(12) Patent Application Publication
(10) Pub. No.: US 2010/0149845 A1
(43) Pub. Date: Jun. 17, 2010

(54) DIGITALLY CONTROLLED SWITCHED-MODE POWER SUPPLY

(76) Inventors: Chi-Hao WU, Taipei City (TW); Chern-Lin Chen, Sindian City (TW)

Correspondence Address: Muncy, Geissler, Olds & Lowe, PLLC, 4000 Legato Road, Suite 310, FAIRFAX, VA, 22033, US

(21) Appl. No.: 12/368,816

(22) Filed: Feb. 10, 2009

(30) Foreign Application Priority Data
Dec. 12, 2008 (TW) 097148392

(51) Int. Cl. H02M 7/06

(52) U.S. Cl. 363/126

(57) ABSTRACT

The present invention relates to a digitally controlled switched-mode power supply, which achieves the effectiveness to save on power and enable more accurate voltage through control of a digital circuit, The power supply is provided with a control circuit, and the control circuit primarily includes a digital unit and a switching controller, wherein functionality of the digital unit enables transmitting an input voltage signal to the switching controller, and when the switching controller transmits voltage to the digital unit, then the digital unit is able to feed a signal back to control the switching controller. Accordingly, the digital unit is able to accurately sense the input load voltage at all times, and thereby achieve advancement to enable saving on power and more accurate voltage.

### BACKGROUND OF THE INVENTION

(a) Field of the Invention

The present invention provides a digitally controlled switched-mode power supply, and more particularly provides a digitally controlled switched-mode power supply able to control any kind of digital circuit system using a digital circuit.

(b) Description of the Prior Art

It can be said that modern technology continually strives for advancement, and there has been continuous progress in electric circuits from the large-scale electric circuits of old to the micro electric circuits of modern times, wherein analog control circuits were adopted for transmission in early electric circuits, until the present stage of advancement enabled digital control circuits to be adopted. Taking a power supply as an example, and referring to FIG. 1 and FIG. 2, which show a block diagram and a circuit diagram respectively of a switched-mode power supply of the prior art, and it can be clearly seen from the drawings that a control circuit 1 is provided with a rectifier unit 11. The rectifier unit 11 transmits a signal to a switching controller 13 through a voltage transformer unit 12, whereupon the switching controller 13 carries out a comparative analysis of the signal, and a frequency generator 131 produces a clock signal with a specific width from the aforementioned comparative signal, which is then output. Furthermore, an optical coupling unit 14 is disposed before the specific signal, and the optical coupling unit 14 is connected to an amplifier and feedback unit (voltage regulator) 15. The amplifier and feedback unit (voltage regulator) 15 is provided with the functionality to detect voltage, and immediately regulates the voltage when excessively high, while simultaneously controlling the size of the flow of current, thereby achieving a regulating objective, and enabling controlling the entire output structure (such as: voltage).

However, the following problems and shortcomings are still in need of improvement when using the aforementioned switched-mode power supply of the prior art:

1. Because the control circuit 1 adopts an amplifier and feedback component (voltage regulator) (TL431), thus, it is unable to accurately control the system, such as the voltage state, and so on.

2. Power consumption of the control circuit 1 is considerably large, and is thus unable to achieve a power saving objective.

Hence, it is the strong desire of the inventor and manufacturers engaged in related art and purpose of the present invention to research, improve and resolve the problems and shortcomings of the aforementioned prior art.

### SUMMARY OF THE INVENTION

Hence, in light of the shortcomings of the aforementioned prior art, the inventor of the present invention, having collected related data, and through evaluation and consideration from many aspects, as well as having accumulated years of experience in related arts, through continuous testing and improvements has designed a new digitally controlled switched-mode power supply as disclosed in the present invention which enables achieving a power saving and accurate voltage through control of a digital circuit.

A primary objective of the present invention lies in: A power supply is provided with a control circuit, and the control circuit comprises a digital unit and a switching controller. The control circuit is provided with an alternating current terminal and a direct current terminal, and the alternating current terminal place is provided with a rectifier unit. The rectifier unit is connected to a voltage transformer unit, and the direct current terminal is electrically connected to the voltage transformer unit and the digital unit. The digital unit is provided with the functionality to deliver input voltage signals, while at the same time able to accurately detect voltage values. The digital unit transmits the input voltage to the switching controller, and when the switching controller transmits voltage to the digital unit, then the digital unit feeds back to control the switching controller. According to the art described above, the present invention provides a breakthrough in solving the existing problems of switched-mode power supplies of the prior art, including unable to accurately control the system (such as: voltage) and large power consumption, and achieves the practical advancement to be able to accurately know voltage load and save on power using the digital unit.

A secondary objective of the present invention lies in: The power supply is primarily provided with the control circuit, and the control circuit comprises the digital unit and the switching controller. The switching controller internally comprises a comparator unit, a frequency generator unit, a control logic unit and an output buffer unit. When the digital unit inputs a voltage signal and transmits it to the switching controller, then the comparator unit immediately compares the signal coming from the digital unit with a waveform, while the frequency generator unit produces a frequency, whereupon the control logic unit determines the aforementioned signal delivered by the comparator unit and the frequency produced by the frequency generator unit to produce a clock signal of specific width, which is then output from the output buffer unit.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a block diagram of a switched-mode power supply of the prior art.

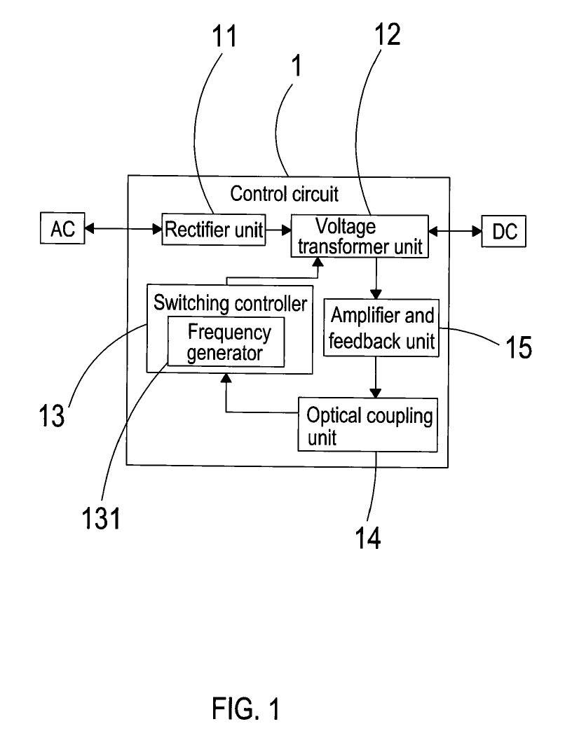

FIG. 2 is a circuit diagram of the switched-mode power supply of the prior art.

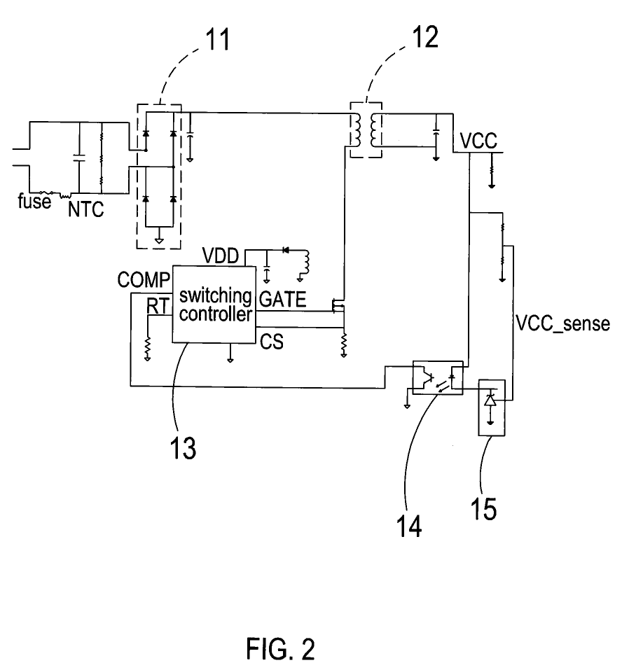

FIG. 3 is a block diagram of a preferred embodiment of the present invention.

FIG. 4 is a circuit diagram of the preferred embodiment of the present invention.

FIG. 5 is an implementation schematic view of a first preferred embodiment of the present invention.

FIG. 6 is an implementation schematic view of a second preferred embodiment of the present invention.

FIG. 7 is an oscillogram of the preferred embodiments of the present invention.

### DETAILED DESCRIPTION OF THE PREFERRED EMBODIMENTS

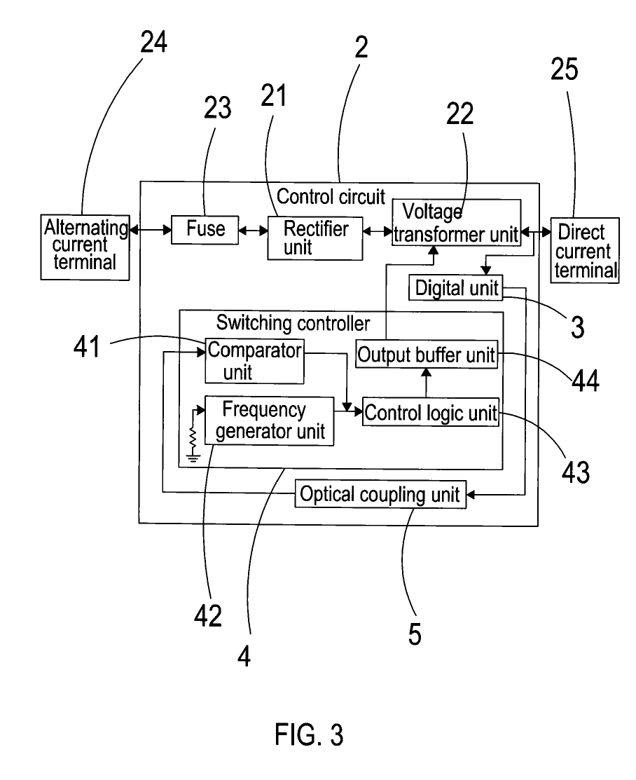

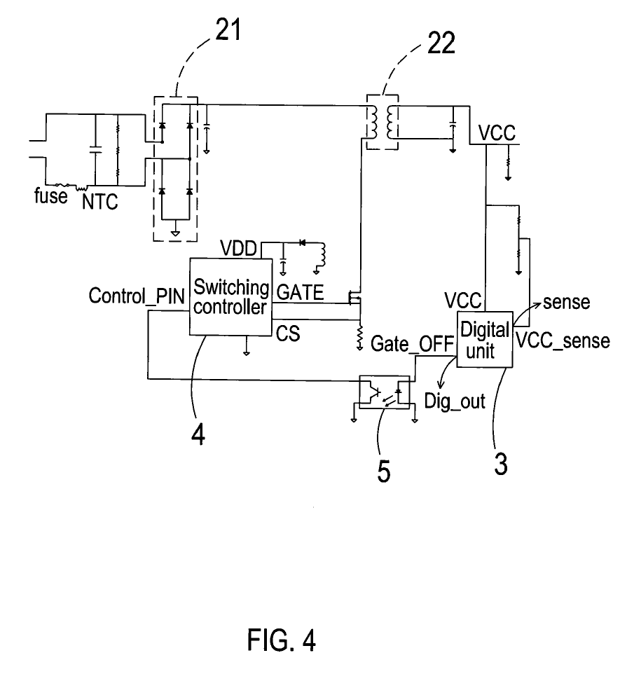

Referring to FIG. 3 and FIG. 4, which show a block diagram and a circuit diagram respectively of a preferred embodiment of the present invention, and it can be clearly seen from the drawings that a power supply is provided with a control circuit 2, and the control circuit 2 is further provided with a rectifier unit 21 and a voltage transformer unit 22, the rectifier unit 21 being a bridge rectifier. Moreover, a fuse 23 is connected to the rectifier unit 21, and the control circuit 2 is provided with at least one input terminal. The input terminals are respectively an alternating current terminal 24 and a direct current terminal 25. The control circuit 2 primarily comprises:

A digital unit 3, the digital unit 3 being provided with the functionality to deliver input voltage signals, while at the same time being able to accurately detect voltage values;

A switching controller 4, the switching controller 4 being able to receive the voltage signals coming from the digital unit 3 and produces a clock signal, after which the clock signal is output, while at the same time the switching controller 4 delivers voltage to the digital unit 3, whereupon the digital unit 3 feeds a signal back to control the switching controller 4. In addition, the switching controller 4 further comprises a comparator unit 41, a frequency generator unit 42, a control logic unit 43 and an output buffer unit 44, Wherein, the comparator unit 41 is used to compare voltage signals coming from the digital unit 3; and the frequency generator unit 42 produces a frequency signal from an externally connected electronic component. The control logic unit 43 is able to determine signals coming from the comparator unit 41 and the frequency generator unit 42 and generate a clock signal of specific width; and the output buffer unit 44 outputs the aforementioned clock signal. Furthermore, an optical coupling unit 5 is located between the digital unit 3 and the switching controller 4.

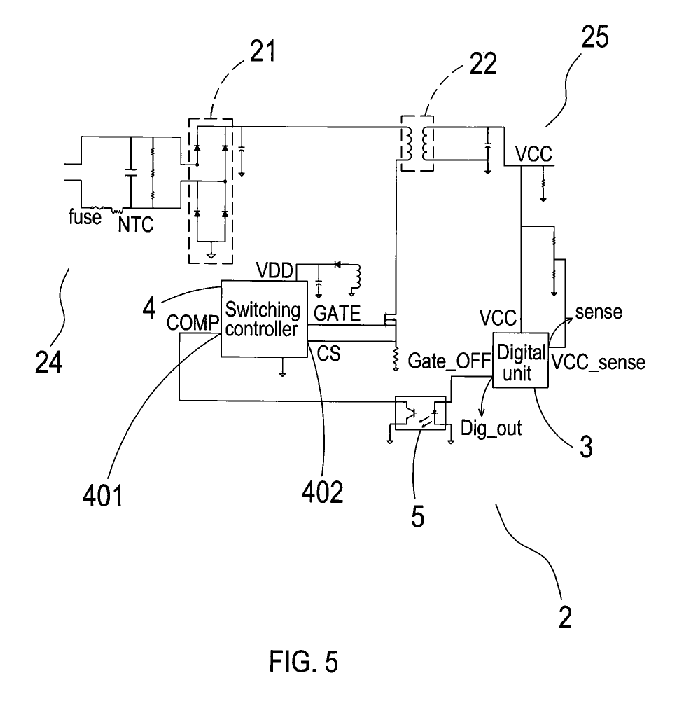

Referring to FIG. 5, which shows an implementation schematic view of a first preferred embodiment according to the present invention, and it can be clearly seen from the drawing that the control circuit 2 comprises the digital unit 3 and the switching controller 4. The control circuit 2 is provided with the alternating current terminal 24 and the direct current terminal 25, and the rectifier unit 21 is located at the position of the alternating current terminal 24. The rectifier unit 21 is connected to the voltage transformer unit 22, and the direct current terminal 25 is electrically connected to the voltage transformer unit 22 and the digital unit 3. The digital unit 3 is provided with the functionality to deliver input voltage signals, while at the same time being able to accurately detect voltage values. Accordingly, the digital unit 3 transmits an input voltage to the switching controller 4, and when the switching controller 4 delivers the voltage to the digital unit 3, then the digital unit 3 feeds back to control the switching controller 4. Furthermore, the optical coupling unit 5 is disposed between the digital unit 3 and the switching controller 4. Accordingly, when the digital unit 3 is used with the control circuit 2, then the digital unit 3 is made to connect with a pin (COMP (Comparator)) 401 of the switching controller 4, whereupon voltage at the pin (COMP) 401 changes along with the changes in the load or the exchange input voltage, and the peak of a waveform (CS (Control Strobe)) 402 interferes with that of the pin (COMP) 401 to determine the opening gate width, thereby regulating the aforementioned change and achieving a stabilized voltage.

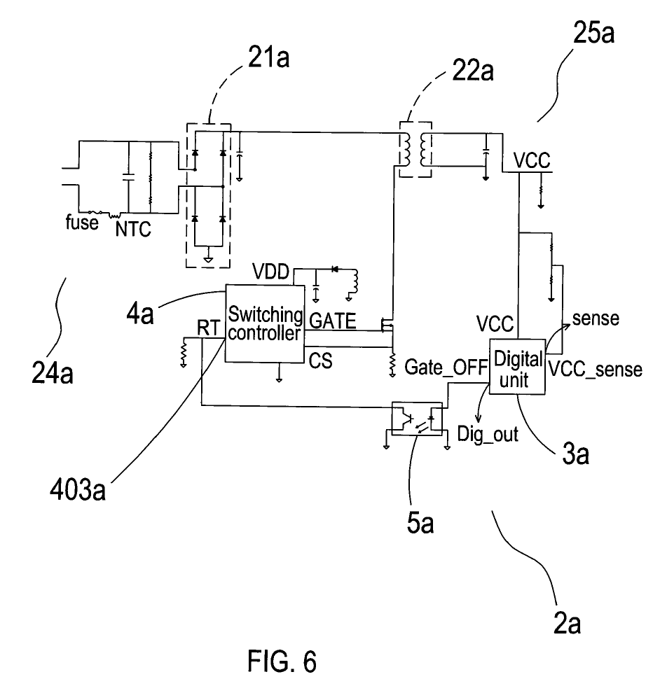

Referring to FIG. 6, which shows an implementation schematic view of a second preferred embodiment according to the present invention, and it can be clearly seen from the drawing that a control circuit 2a comprises a digital unit 3a and a switching controller 4a. The control circuit 2a is provided with an alternating current terminal 24a and a direct current terminal 25a, and a rectifier unit 21a is located at the position of the alternating current terminal 24a. The rectifier unit 21a is connected to a voltage transformer unit 22a, and the direct current terminal 25a is electrically connected to the voltage transformer unit 22a and the digital unit 3a. The digital unit 3a is provided with the functionality to deliver input voltage signals, while at the same time being able to accurately detect voltage values. The digital unit 3a transmits the input voltage to the switching controller 4a, and when the switching controller 4a delivers the voltage to the digital unit 3a, then the digital unit 3a feeds back to control the switching controller 4a again. Furthermore, an optical coupling unit 5a is disposed between the digital unit 3a and the switching controller 4a. Accordingly, when the digital unit 3a is used the control circuit 2a, then the digital unit 3a is made to connect with a pin (RT (Remote Terminal)) 403a of the switching controller 4a,

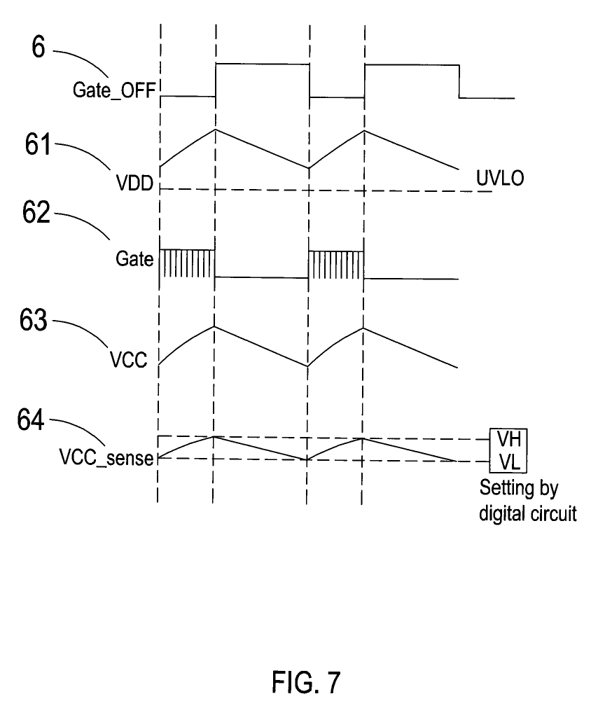

Referring to FIG. 7, which shows an oscillogram of the preferred embodiments according to the present invention, and waveforms of a gate (Gate_OFF) signal 6, a power MOS (Metal oxide semiconductor) signal (VDD (Virtual Device Driver)) 61, a gate 62, a power transistor signal (VCC (Virtual Circuit Connection)) 63 and a power transistor signal (VCC_sense) 64 can be clearly seen from the drawing.

Hence, the key factors that enable the digitally controlled switched-mode power supply of the present invention to improve on the prior art are described as follows:

Use of the digital unit 3 enables accurate detection of input load voltages, and using the digital unit 3 effectively achieves a power saving objective. Furthermore, the digital unit 3 is provided with the advantage whereby when the switching controller 4 delivers voltage to the digital unit 3, then the digital unit 3 is able to feed back to control the switching controller 4.

In conclusion, the digitally controlled switched-mode power supply of the present invention is clearly able to achieve the effectiveness and objectives as disclosed when in use, and is indeed a practical and exceptional invention that complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A digitally controlled switched-mode power supply, wherein a power supply is provided with a control circuit, and the control circuit comprises:
a digital unit, the digital unit is provided with the functionality to deliver input voltage signals, while at the same time is able to accurately detect voltage values; and
a switching controller, the switching controller receives the voltage signals coming from the digital unit and produces a clock signal, after which the clock signal is output, while at the same time the switching controller delivers voltage to the digital unit, whereupon the digital unit feeds back to control the switching controller.

2. The digitally controlled switched-mode power supply according to claim 1, wherein the switching controller comprises:
a comparator unit, the comparator unit being used to compare voltage signals coming from the digital unit;
a frequency generator unit, the frequency generator unit produces a frequency signal from an externally connected electronic component;
a control logic unit, the control logic unit is able to determine signals coming from the comparator unit and the frequency generator unit and generate a clock signal of specific width; and
an output buffer unit, the output buffer unit being used to output the clock signal.

3. The digitally controlled switched-mode power supply according to claim 1, wherein an optical coupling unit is located between the digital unit and the switching controller.

4. The digitally controlled switched-mode power supply according to claim 1, wherein the control circuit is further provided with a rectifier unit and a voltage transformer unit.

5. The digitally controlled switched-mode power supply according to claim 4, wherein a fuse is connected to the rectifier unit.

6. The digitally controlled switched-mode power supply according to claim 1, wherein the control circuit is provided with at least one input terminal.

7. The digitally controlled switched-mode power supply according to claim 6, wherein the input terminals are respectively an alternating current terminal and a direct current terminal.

8. The digitally controlled switched-mode power supply according to claim 4, wherein the rectifier unit is a bridge rectifier.
